(19) United States
(12) Patent Application Publication
(10) Pub. No.: US 2004/0049429 A1
(43) Pub. Date: Mar. 11, 2004

(54) Method and management system for tolerance discount sale offer (TDO)

(76) Inventor: Maher Mohsen Nasr Khamis Al Sayari, Abu Dhabi (AE)

Correspondence Address: Thomas R Vigil, Welsh & Kratz Ltd, 120 South Riverside Plaza, 22nd Floor, Chicago, IL, 60606, US

(21) Appl. No.: 09/792,972

(22) Filed: Feb. 26, 2001

(51) Int. Cl. G06F 17/60

(52) U.S. Cl. 705/26

(57) ABSTRACT

The method and management system for tolerance discount offers (TDO's) is applied to several products and services such as airline tickets, hotels, rental cars, computer real estate, groceries, etc., and is based on a combined buyer driven system and a seller driven system. The TDO method and management system evaluates each received TDO which are submitted by both seller and buyer and which are stored in a database. The method and system apply certain disclosed criteria, and, if a given TDO matches the criteria, transaction is transacted, and if not, the transaction is rejected or expires. The buyers and sellers each obtain the best discounted goods, service or sales price and the identity of the buyer or seller can be maintained confidential relative to other buyers or other sellers.

### BACKGROUND OF THE INVENTION

1. Field of the Invention

The present invention relates to a method and management system for tolerance discount sale offers (TDO). The system can be applied to services, commodities and products including consumable, manufactured and durable goods, such as airline tickets, hotels reservation, rental cars, automobiles, computers and any saleable items. In particular, the invention is concerned with a method and system to conclude a business transaction online in efficient manner, allowing buyer to have a certain discount and seller to give possible discount.

2. Description of the Prior Art

Analysis indicated that in five years or less, sales transactions on the Internet will be in the neighborhood of trillion dollar transactions. In short, online commerce is a fast growing business. To facilitate these transactions, there is a need for a new flexible method and management system to speed up conclusion of sales.

The fundamental opportunity offered by the Internet is for a supplier to gain direct access to consumers, without the attendant costs associated with the maintenance of physical distribution channels, i.e., people, bricks and mortar. In the electronic medium competitors can emerge from anywhere in the world. They are not necessarily limited by geography.

Generally, electronic commerce can be described in many ways; the most comprehensive definition of electronic commerce is the business environment in which information for buying and selling of goods and services moves electronically. In other words, any use of electronic medium is considered part of electronic commerce.

So far most sales transactions are either seller driven, i.e. the seller decides the price of goods and services or buyer driven system where the buyer decides the price. The existence of the combination of buyer+seller driven systems can greatly enhance the growing electronic commerce by allowing sellers and buyers to benefit of using such method and system.

Several methods have been described in the prior art to match buyer with seller of various types of goods and services.

For example, U.S. Pat. No. 5,615,269 (to Micali) described an Ideal Electronic negotiations, however, this negotiations process depend on a plurality of trustees.

U.S. Pat. No. 5,664,115 (to Fraser) describes an interactive computer system to match buyers and sellers of real estate, businesses and other property using the Internet. The system is based on a search result submitted to the buyer who can identify information, which is provided to the seller. The system permits automatic evaluation of buyers.

U.S. Pat. No. 6,041,308 (to Walker, et al), and U.S. Pat. No. 6,085,169 (to Walker, et al) are mainly directed to conditional purchase offer, which is a buyer driven system.

### SUMMARY OF THE INVENTION

The present invention relates to a method and management system for tolerance discount sale offers (TDO). The system can be applied to several products and services such as airline tickets, hotels, rental cars, computers, real estate, groceries, etc.

The method of the invention is based on the combination of both buyer driven+seller driven systems.

In this method and system, the buyer chooses the product and/or service he wants to buy and places the purchase offer in terms of defined discount rate, cash back, price, or rebate with a spread in the discount rate such as a percentage (%) or price. The offer contains one or more buyer defined requests.

The buyers offer is guaranteed by an account charge, such as credit card or a debt card, or any other accounts, and thereby provides sellers with a mechanism and technique for enforcing any agreement that might be reached to conclude a deal with the buyer.

Unlike the conditional purchase offer (CPO) management system described in U.S. Pat. Nos. 6,041,308 and 6,085,169, the tolerance discount sale management system (TDO) recognizes the wants and needs of sellers and buyers and fills the gap to conclude a more efficient mechanism in buying and selling.

Therefore, an object of this invention is to provide a system for Tolerance Discount Sale Offer (TDO).

Another object of this invention is to provide a management system and method to allow people to trade in an efficient, quick and easy way to save time and money.

Another object of the invention is to provide a management system and method which gives both the buyer and the seller the chance to bargain, i.e. buyer+seller driven system.

Thus, the present invention stimulates demand and curbs buyer dissatisfaction by providing a discount rate, percentage or price. An addition is that a predefined eligibility criteria can be used to stimulate demand in a desired manner, and thereby increase the reasonability of tolerance discount sale. For example, the TDO management system can encourage buyers to submit TDO purchase offers within the more likely acceptable discounted price.

These objects as well as other object can be achieved by the present method and management system as described below in detail.

### BRIEF DESCRIPTION OF THE DRAWINGS

FIG. 1 is a schematic block diagram illustrating a system for Tolerance Discount Sale Offer in accordance with the present invention.

FIG. 2 is a schematic block diagram illustrating in detail the mechanism of applying the management of the invention.

FIG. 3 is a schematic block diagram showing in more detail the process of TDO evaluation system of the sellers as shown in FIG. 2.

FIG. 4 is a schematic block diagram showing in more detail the process of TDO evaluation system of the buyer as shown in FIG. 2.

FIG. 5 is a diagram showing an embodiment of the process of matching bids and applying the TDO formula.

FIG. 6 diagram showing the final execution of the TDO sale process.

### DESCRIPTION OF THE PREFERRED EMBODIMENT(S)

The present invention relates to a method and management system for tolerance discount sale offers (TDO). The system can be applied to several products and services such as airline tickets, hotels, rental cars, computers, real estate, groceries, etc.

The method of the invention is based on the combination of both buyer driven+seller driven systems.

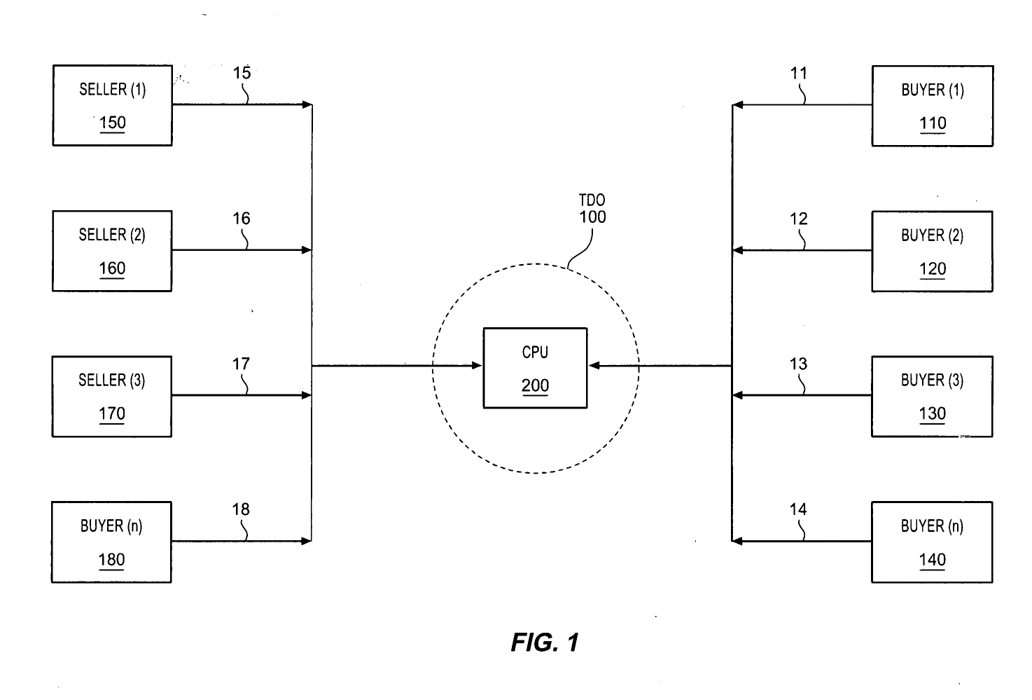

Referring now to FIG. 1, which is a schematic block diagram illustrating a System for Tolerance Discount Sale Offer in accordance with the present invention, a buyer 1 (110), a buyer 2 (120), a buyer 3 (130) and a buyer n (140) enter the site and system searching for a certain product/service. The system display items offered by a seller 1 (150), a seller 2 (160), a seller 3 (170) and a seller n (180) together with full features, advantages of the product along with market price served as a benchmark.

The buyer (110) submit his request (11) along with a discount percentage/cash back in terms of numbers or percentage rate with tolerance level rate. In the same way, buyers (120), (130) and (140) submit their requests (12), (13) and (14) respectively to TDO (100).

The sellers on the other hand, enter the system and offer their items with all features, advantages and market price. The seller 1 (150), seller 2 (160), seller 3 (170) and seller n (180) feeds the system with discount rate/cash back in terms of digital numbers or percentage rate (15), (16), (17) and (18) respectively with tolerance level rate.

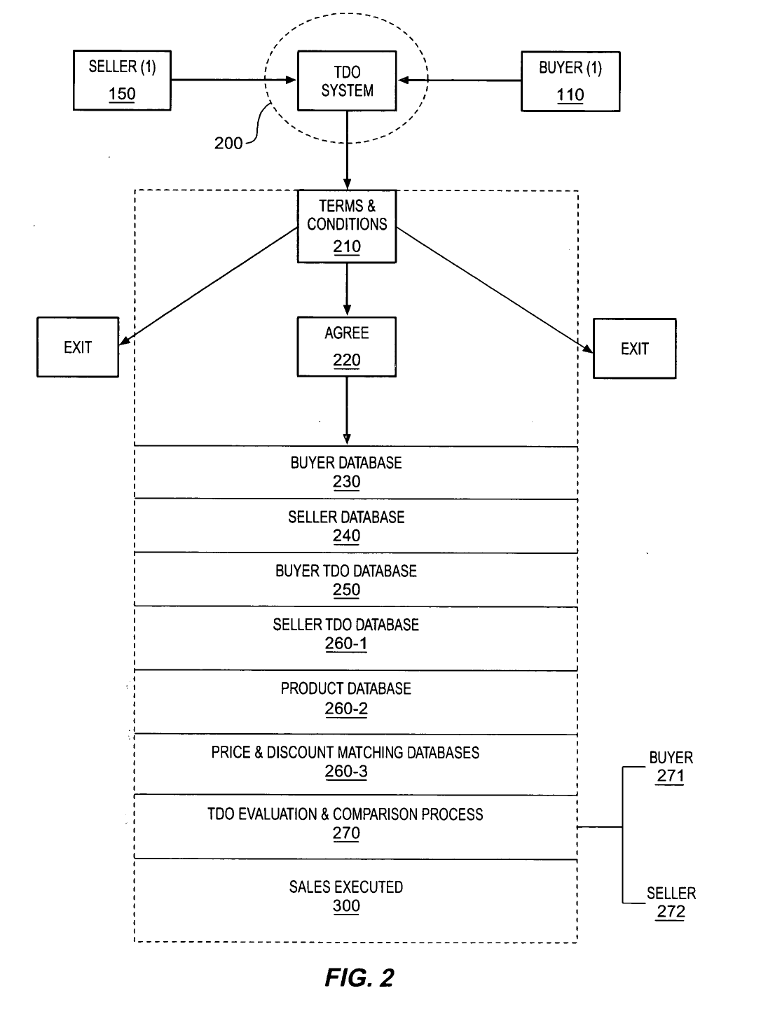

Referring now to FIG. 2, which is a schematic block diagram illustrating in details of the mechanism of applying the management of the invention, buyer (110) and seller (150) are online trying to finalize a transaction. Buyer (110) submits his request with a discount rate supported with tolerance level rate and seller (150) offers his items with a discount rate supported with tolerance level rate. All data are fed to a CPU (200) wherein the terms and conditions (210) are entered. Buyer (110) either agrees to terms and conditions and in this case he will continue to step (220), or he can reject and refuse terms and conditions and in this case he can exit the system. This same procedure is also applied to the seller (150) who can either accept and in this case he can continue or reject and in this case he can exit. The system collects data from both parties and sorts it in separate databases, buyer database (230) and seller databases (240). The buyer database is provided with TDO databases, whereas seller databases includes TDO databases (260-1) and product (260-2), price & discount databases (260-3). The TDO system, once all databases are fed and processed, starts the final process of evaluating and comparison applying the TDO code (270) with consideration of the tolerance from both parties to execute and finalize a sale process (300).

The TDO compares and evaluates discount rates.

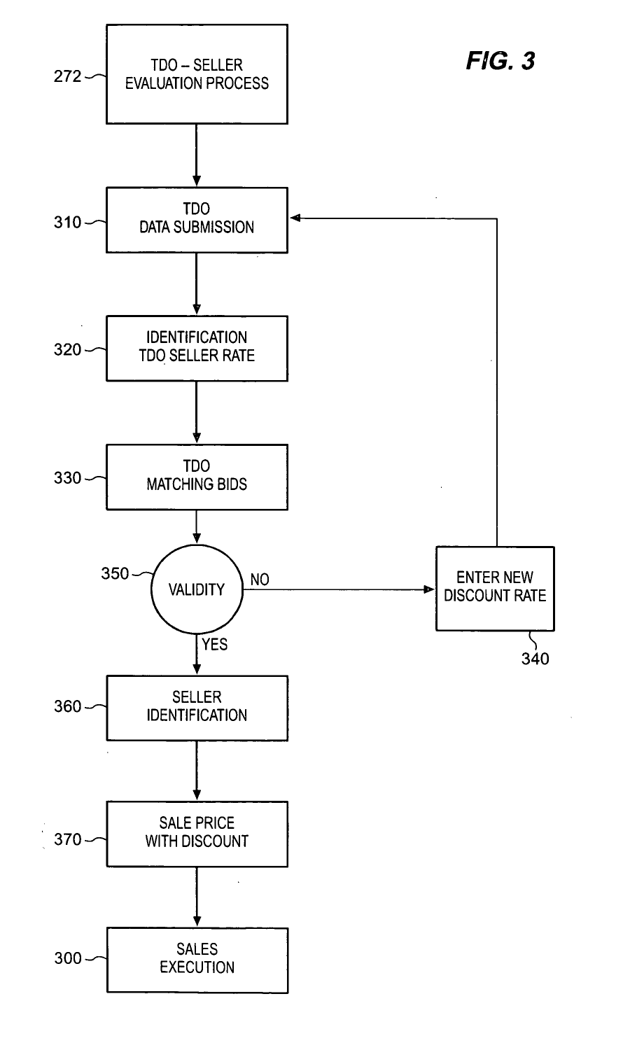

FIG. 3 is a schematic block diagram showing in more detail the process of the TDO evaluation system of the sellers (272) shown in FIG. 2 where the TDO evaluation system receives TDO data from the seller (310) as soon as the data is received, and the system identifies the seller discount rate (320). After identifying seller discount rates the system matches bids (330) and, having matched bids, the system reaches a point of deciding validation of bids (350), so if the bid is valid, the system proceeds to the next step. If, however, the bid is not valid, the system will request a re-submission of a new offer (340), which will be handled as a new data in (310).

Once the bids are matched and valid, the system identifies the seller (360) and identifies the sales price with the TDO discount rate (370) and the transaction is executed at (300).

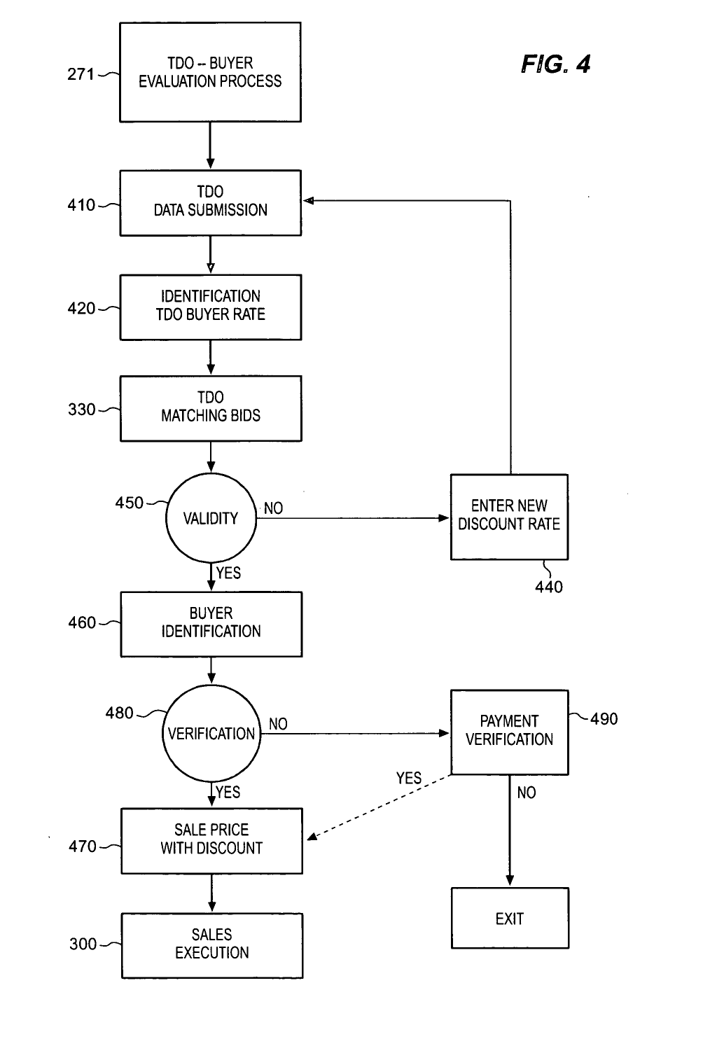

FIG. 4 is a schematic block diagram showing in more details the process of the TDO evaluation system of the buyer (271) shown in FIG. 2 and identical to the system described for the seller but the buyer uses this specific system. The TDO buyer evaluation system comprises receiving TDO data from the buyer (410). As soon as the data is received, the system identifies the buyer discount rate (420). After identifying the buyer's discount rates, the system matches bids (330). Having matched bids, the system reaches a point of deciding validation of bids (450). So, if the bid is valid, the system proceeds to the next step. If, however, the bid is not valid, the system will request re-submission of a new offer (440) which will be handled as a new data in at (410).

Once the bids are matched and valid, the system identifies the buyer (460) and requests identification of payment mode (480), which is verified and if the payment mode is accepted and verified, the sales price with TDO discount will be identified at (470) and the sale is executed (300). If, on the other hand, the payment mode is rejected or not verified, the system will request re-submission of payment, which will be re-verified (490) and if accepted, the system proceeds to identification of the sales price (470), if such payment is rejected or unverified, the system will ask the buyer to exit.

The present invention will now be described more detail with reference to the following Examples.

### EXAMPLE (1)

In a sales transaction, a buyer did submit a specific offer to buy a certain item at a discount rate ranging from 10% to 18%. The difference between the upper limit and lower limit represent the tolerance. In other words, the buyer is giving an offer to buy the item with a minimum discount of 10% and maximum discount of 18%, the tolerance of the buyer in this case is 8%.

The seller, on the other hand, is offering the item for sale at a discount rate ranging from 6% to 13% i.e. a minimum discount offered is 6% and the maximum discount offered is 13%, a tolerance in this case for the seller of 7%.

The system will analyze the transaction to be concluded in accordance with two rates namely:

Buyer tolerance rates: Rate 1=Any rate ranging from 10 to 18%

Seller tolerance rate: Rate2=Any rate ranging from 6 to 13%.

The general understanding of this situation is that the buyer is willing to buy at a discount rate of 10%, however, sell at a discount would prefer to buy at a discount rate not less than 10% and not exceeding 18%. The same is also applied to seller who is willing not less than 6% and not exceeding 13%.

The TDO management system will match the bids applying the following rules assuming the following:

B1=buyer lower bound bid discount rate (BLB).

B2=Buyer upper bound bid discount rate (BUB).

A1=Seller lower bound ask discount rate (SLB).

A2=Seller upper bound ask discount rate (SUB).

IF A2=B1, then

Applicable discount rate will be A2

IF not,

A1=B2, then

Applicable Discount Rate will be (A1)

If The system did not detect any of the above criteria; no transaction will be concluded.

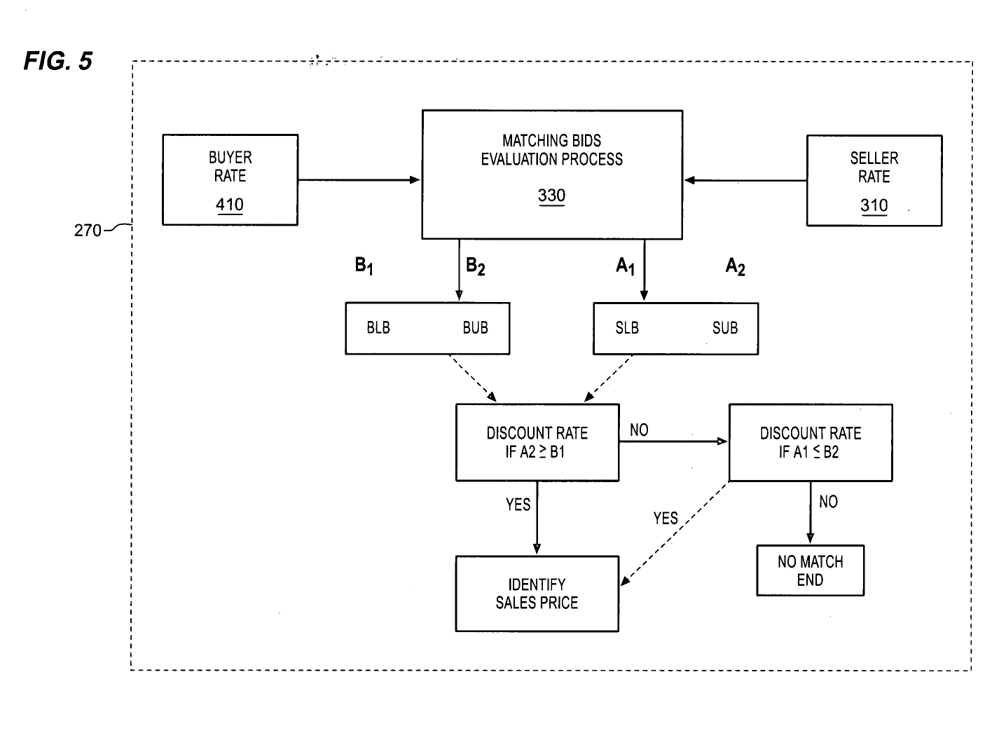

FIG. 5 simplifies the process wherein matching bids evaluation unit 270/(330) receives buyer rate (410) and seller rate (310). The system identifies the value of BLB, BUB, SLB and SUB, B1, B2, A1 and A2, respectively, and the system applies the main criteria and sales are proceeded if A2=B1 or if A1=B2 and sale can be successfully completed by identifying seller, sales price with discount and sale execution. If on the other hand, the system could not apply the criteria, both seller and buyer will be requested to re-enter a new discount rate or new price, which will be processed further in the same way.

Thus, the present invention stimulates demand and curbs buyer dissatisfaction by providing a discount rate, percentage or price. In addition, the predefined eligibility criteria can be used to stimulate demand in a desired manner, and thereby increase the reasonability of tolerance discount sale. For example, the TDO management system can encourage buyers to submit TDO purchase offers within the more likely acceptable discounted price.

### EXAMPLE (2)

Buyer X is on line and wishes to buy a product Z and would like to go to the TDO system. Buyer X submit his TDO, i.e., with a bid rate to buy at a discount of between 50% and 80%, so his tolerance rate is 30% (tolerance rate is the difference between the maximum offered discount and the minimum offered discount, e.g., 80−50=30). On the other hand, an on-line seller is offering product Z at a sale discount rate ranging from 10% to 20%; i.e. his tolerance rate is 10%.

In this case no deal will be consummated. The same will be apply to TDO using price, cash back, rebate.

### EXAMPLE (3)

Buyer X is on line and want to buy product Z and would like to go to the TDO system. Buyer X submits his TDO i.e. with a bid price to buy at discount price ranging from US $ 1,000 to US$ 1,500. The tolerance discount price is US$500. On the other hand, seller is on line and is trying to sell product Z. He also goes to the TDO and submit his ask offer discount price. After he feeds in his market price, say US $ 2,000, he submits his TDO to sell product Z at discount price ranging from US $ 1,400 to US $ 1,800. The tolerance discount price is US $ 400 for seller.

Using the TDO formula, the applicable sale price in this example is US $ 1,400.

However the sellers feed the TDO with their market price. Instantly the system collect the sale prices from the sellers for the same product and display instantly to each seller the weighted sale price/average price to be served as a price bench mark for the particular product. The same will be displayed to the buyer on the other hand, without disclosing the seller name and seller price. The system only discloses averaged market price to be served as a benchmark. The mechanism behind the benchmark price for any particular product is to prevent the both seller and the buyer to misuse the TDO system and is a method to give logical information to both parties to submit their bids efficiently.

The TDO management system stimulates seller and buyer to submit their bid-ask discount rates or discounted prices or percentages. The upper and lower bounds are taken as the flexible way to increase probability of consummating the deal in the very best, efficient and fast way. It should also be noted that the TDO management system works on a first come first served basis. In other words, the process of TDO management system offers several advantages to both buyer and seller simultaneously.

Advantages given to buyers include offering a wide range of products and services including for example commodities like computers, automobiles grocery, printers, scanners, furniture, consumer products and virtually any kind of products; and services like car rental, travel booking, hotel reservation and any other services. All these goods and services are offered by a large number of sellers from everywhere in the world all concentrated in one center, the Internet, which gives the buyer the advantage of putting certain buying conditions through the TDO and choosing the sale rate, price or percentage or cash back.

As for the seller, it is well known that sellers are spending a lot of money to market their products through advertising in different media e.g. newspapers, magazines, TV, Internet; hiring sales men and applying promotion plans with published incentives to buy, such as a sale prices, discount rate, coupon and cash back etc. The TDO management system according to the invention saves a lot of money spent in marketing, advertising and overhead in general.

In the classical selling operations, not so many potential buyers can be well aware of the products since each buyer has his own way of finding his products. The TDO management system according to the invention makes the product of the seller available for millions of potential buyers who are using the Internet.

Furthermore, in the traditional selling methods, profit margin may be deteriorating since the seller has already published a fixed discount offer. This can lead to an increase in competition through reducing prices, which may reduce, bargaining power of sellers with potential buyers.

The TDO management system provides an efficient way for the seller to be assured that whatever discount he offers would be kept confidential without announcing the exact discount he offered which keeps his competitors away from price reduction and more competition.

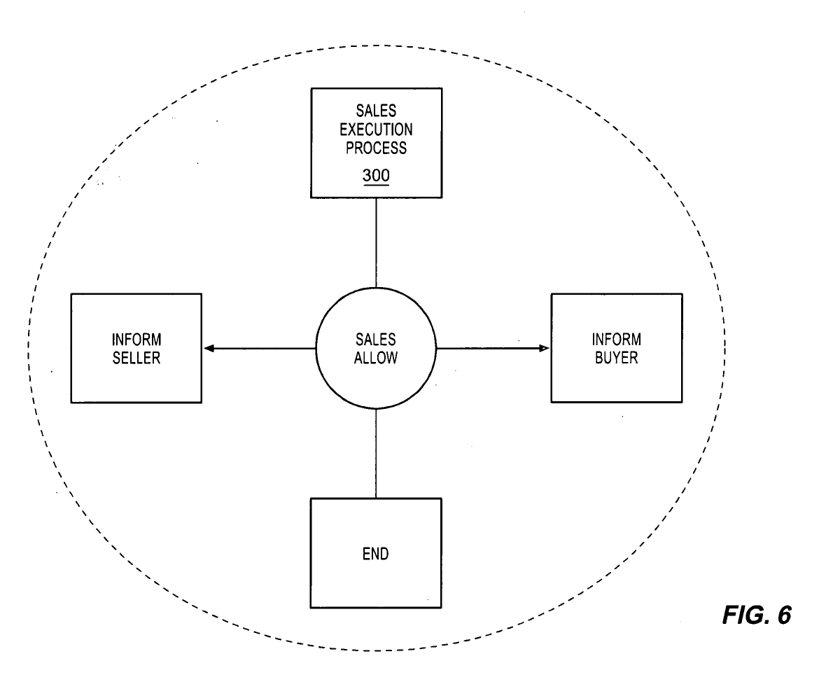

Reverting now to FIG. 6, which is a diagram showing the final execution of the TDO sale process, after evaluation of all bids and application of the above outlined criteria, the sales are either accepted or rejected. In case of rejection, sellers and buyers shall be requested to re-enter new offers which will be handled in exactly the same way of verification and evaluation and application of the method of the invention until terms are applied and a sale is due for execution. Once the sale is executed, it is allowed, and system will inform both sides, i.e. the seller and the buyer. The system informs both parties of the agreed rate, price or percentage and they have to confirm acceptance and, once they confirmed the acceptance of the deal, the transaction is allowed and executed to the successful end. In case of high priced items that buyer's mode of payment is not applicable to carry on such transaction. Otherwise, in case of normal items, which the buyer mode of payment can carry on such transaction (charge), once the sale is concluded, the buyer mode of payment is automatically charged and receipt will be sent to him on-line. Seller, on the other hand, will be informed to fulfill his obligation to deliver the good/service.

Having concluded the deal, the buyer will be happy because he got the best price, which can not be offered at the market place. The seller is also happy because he has made a deal and offered a discount, which will not be disclosed, to his competitors.

Among the advantages of the TDO management system of the invention, is that the system always decides the validity of the offer submitted by either the buyer or the seller. If the offer is accepted and matches sales, a deal will be successfully completed and, if not, the system will automatically clear invalid bids after a predefined period, 24 hours, for example. However both seller and buyer can determine the validity of the offer, if the offer is not executed to take advantage of the plurality method of the system.

A successful deal can be made according to this invention if large number of buyers and sellers are using the system. It is to be noted that flexibility of pricing offered by the TDO management system of this invention permit buyers and seller to get the best price.

It is to be understood that the embodiments and variations shown and described herein are merely illustrative of the principles of this invention and that various modifications may be implemented by those skilled in the art without departing from the scope and spirit of the invention and that the invention is only to be limited by the appended claims.

I claim:

1. An on-line method and management system for tolerance discount offers (TDO's) which can be applied to services, commodities and products including consumable, manufactured, durable goods, and any saleable items, said system being characterized by being both a buyer driven system and a seller driven system.

2. The on-line method and management system according to claim 1 including the step of submitting a request by a buyer with a discount rate in the form of digital numbers or percentage rate and with a tolerance level rate.

3. The on-line method and management system according to claim 1 including the step of submitting an offer to sell by a seller with all features, advantages and market price for the goods or services and with a discount rate in the form of digital numbers or percentage rate and with a tolerance level rate.

4. The on-line system and method according to claim 1 being implemented with a global communications network (the Internet), with a server computer which has said method and system stored therein and which is connected to said global communications network and with client computers connected to said global communications network.

5. An on-line method and management system characterized comprising a tolerance discount offer (TDO) evaluation systems for both buyers and sellers thereby giving equal chance for both seller and buyer to obtain the most favorable sales price and discount, said TDO evaluation system for the seller receiving data, identifying the seller's rate and match bids, and said system, once bids are matched, identifies to the buyer, the seller, the sales price with a discount rate and executes the sales transaction.

6. The on-line method and management system according to claim 5 wherein bids not matched are rejected and the system requests a re-submission of a new offer.

7. The on-line method and management system according to claim 5, wherein the TDO evaluation system for the buyer receiving data, identifies the buyer's rate and match bids, and, once bids are matched the system, identifies the buyer, verifies the mode of payment and the sales price with a discount rate and executes the sales transaction.

8. The on-line method and management system according to claim 5 including the step of verifying payment and, if the payment is not accepted, the step of requesting the buyer to exit, and if accepted, proceeding to identify the sale price with TDO price and successfully finalizing the transaction.

9. The on-line method and management system according to claim 5 including the step of requesting the buyer whose payment was not verified to re-enter another payment mode for further verification, and if buyer's second payment mode is not verified terminating the buyers offer.

10. The on-line system and method according to claim 9 being implemented with a global communications network (the Internet), with a server computer which has said method and system stored therein and which is connected to said global communications network and with client computers connected to said global communications network.

11. An on-line method and management system comprising: receiving, on-line, conditional tolerance discount offer (TDO) from a potential buyer to buy a certain product, the offer containing a lower boundary and an upper boundary resulting in a tolerance rate and/or price and/or percentage in a database; receiving, on-line conditional TDO from a potential seller wishing to sell a certain product, the offer containing a lower boundary and an upper boundary that gives tolerance rate and/or price and/or percentage in a database; processing buyer tolerance discount offers and matching them with selling tolerance discount offers available at the databases; and matching buyer tolerance discount offers and the tolerance rate for same with selling discount tolerance offers and the tolerance rate for same.

12. The on-line method and management system according to claim 11 wherein the tolerance rate is the difference between the maximum offer and the minimum offer.

13. The system and method according to claim 12 wherein the system recognizes any rate/price that ranges from the upper boundary and the lower boundary.

14. The system and method according to claim 13 wherein the system recognizes any rate/price that ranges from lower bids at or above the lower boundary and higher bids at or below the upper boundary.

15. The system and method according to claim 14 wherein seller asking rate/price is any value between the lower seller boundary and the higher seller boundary.

16. The on-line method and management system according to claim 11 wherein the identity of the seller is maintained confidential.

17. The on-line method and management system according to claim 11 wherein the buyer lower boundary bid discount rate (BLB) is identified as B1 and the buyer upper boundary bid discount rate (BUB) is identified as B2.

18. The on-line method and management system according to claim 17 wherein the seller lower boundary asking discount rate (SLB) is identified as A1 and the seller upper boundary asking discount rate (SUB) is identified as A2.

19. The on-line method and management system according to claim 18 wherein the steps of evaluating and comparing apply the following criteria:
A2=B1
A1=B2.

20. The on-line method and management system according to claim 19 wherein the evaluation system compares and defines the following:
IF
(1) A2=B1, then a sale is transacted,
IF not, then
(2) A1=B2, then a sale is transacted, and
the Applicable Discount Rate will be (A2) in (1), and
the Applicable Discount rate will be (A1) in (2).

21. The on-line method and management system according to claim 19 wherein, IF the system does not detect any of the above criteria, no transaction will be concluded.

22. The on-line method and management system according to claim 11 wherein a benchmark price is provided for each product using the weighting average method.

23. The on-line method and management system according to claim 22 wherein a weighting average price for specified product is provided to facilitate the buyer's determination of an appropriate bid rate/price.

24. The on-line method and system according to claim 22 wherein the seller can view the benchmark price to determine an appropriate ask rate/price.

25. The on-line method and system according to claim 24 wherein the benchmark price for a specified product/service can be changed as new sellers feed in new prices to the system.

26. The on-line method and system according to claim 25 wherein new seller price feeds into the system enable the TDO system to automatically re-calculate the weighting average for the overall price.

27. The on-line method and system according to 11 wherein the buyers are prevented from submitting more than one TDO at one time for the same product/service.

28. The on-line method and system of claim 11 wherein the sellers are prevented from submitting more than one TDO at one time for the same product/service.

29. The on-line system and method of claim 11 wherein the system conducts parallel processing of sale executions.

30. The on-line system and method according to claim 11 being implemented with a global communications network (the Internet), with a server computer which has said method and system stored therein and which is connected to said global communications network and with client computers connected to said global communications network.

31. The on-line method and management system of claim 19 wherein, if buyer submits only one value in term of price/rate, the system will consider the value as both upper and lower value and will apply said criteria.

32. The on-line method and management system of claim 19 wherein, if seller submit only one value in term of price/rate, the system will consider the value as both upper and lower value and will apply said criteria.

33. The on-line method and system according to claim 31 in which, if both buyer and seller submit only one value each, then the system will apply said criteria and a sale will be A=B.

34. The on-line method and system according to claim 32 in which, if both buyer and seller submit only one value each, then the system will apply said criteria and a sale will be A=B.
